(19) United States
(12) Patent Application Publication
(10) Pub. No.: US 2005/0053800 A1
(43) Pub. Date: Mar. 10, 2005

(54) Method for post deposition of beta phase nickel aluminide coatings

(75) Inventors: Joseph David Rigney, Milford, OH (US); Mark A. Martina, Cincinnati, OH (US); Michael James Weimer, Loveland, OH (US)

Correspondence Address: MCNEES WALLACE & NURICK LLC, 100 PINE STREET, P.O. BOX 1166, HARRISBURG, PA, 17108-1166, US

(73) Assignee: General Electric Company, Schenectady, NY (US)

(21) Appl. No.: 10/655,283

(22) Filed: Sep. 4, 2003

(51) Int. Cl. B05D 3/12; B32B 15/00

(52) U.S. Cl. 428/687; 427/446; 427/348; 427/355; 428/680; 428/650; 428/332

(57) ABSTRACT

A method for producing an article such as a turbine component that is coated with a β-phase, high aluminum content coating, such as substantially stoichiometric NiAl, and which has a surface finish suitable for application of a ceramic topcoat. The method involves heating the coated article to near the brittle-ductile transition temperature of the coating and impacting the coating with particles of a preselected size so that the brittle coating is not adversely affected by chipping or breakage. The impacting produces a surface finish of 120 micro-inches or finer so that a ceramic thermal barrier layer can be applied over the coating. The preferred method of improving the surface finish utilizes heated peening media to impact the heated coated article, thus allowing use of a broader selection of peening media.

### BACKGROUND OF THE INVENTION

This invention is directed to a method for modifying a brittle environmental or bond coating applied to turbine engine components, and specifically to densification of substantially stoichiometric NiAl, and PtAl coatings having key quality characteristics required to protect the underlying turbine component in a high temperature, oxidative and corrosive atmosphere while also permitting application of long life thermal barrier topcoats.

Many systems and improvements to thermal spray coating processes and systems have been set forth in the prior art for providing protection to turbine components, such as airfoils, turbine blades, turbine vanes, combuster components, turbine shrouds and other components which comprise the hot section of a gas turbine, from the combined effects of high temperatures, an oxidizing environment and hot corrosive gases and deposits. These improvements include new formulations for the materials used in components and include exotic and expensive nickel-based superalloys. Other solutions have included application of coating systems. These coating systems include environmental coating systems and thermal barrier coating systems. The environmental coating systems include aluminides, such as nickel aluminides, platinum aluminides and combinations thereof. A multitude of improvements in these coatings and in methods of applying these coatings has been set forth that increase the life of the system, and developments in these improvements continue. In certain systems, thermal barrier coatings (TBC's) in the form of a ceramic are applied over the environmental coatings. In other systems, an overlay bond coat such as a MCrAlX where M is an element selected from Ni, Co, Fe or combinations of these elements are applied as an intermediary between the airfoil and the applied ceramic. The bond coat desirably also is employed to improve the environmental performance of the system. These aluminides (usually mostly β-NiAl) and MCrAlX coatings are substantially brittle materials compared to the underlying superalloys, being comprised substantially of gamma or gamma+gamma prime phases, although small amounts of higher Al content beta-phases may be present, particularly in the aluminides. More recently, primarily β-phase NiAl coatings have been applied as bond coats or overlay coatings.

Although many of the solutions presented by the use of the coatings such as β-phase nickel aluminides do provide improvements to the performance of the applied environmental coatings, one of the problems is that β-phase NiAl is a substantially stoichiometric composition, even when additions of a rare earth element is made on a substitutional basis. These primarily β-phase compositions have high Al content and exhibit outstanding oxidation resistance and act as stable bond coats that improve the system's resistance to spallation of applied thermal barrier topcoats. However, primarily β-phase NiAl has a higher melting point and is an extremely brittle material at ambient temperatures, with very low tensile ductility.

The prior art thermal spray methods for application of the β-phase nickel aluminides produced a coating applied to a substrate with some performance limitations compared to coatings applied by physical vapor depositions (PVD). Because of concerns with brittleness and high melting points, thermal spray methods can not be used to achieve a desirably dense substantially stoichiometric composition. These thermal spray techniques include but are not limited to low pressure plasma spray (LPPS), vacuum plasma spray (VPS), high velocity oxy-fuel (HVOF), air plasma spray (APS) and detonation gun (D-gun), that thermally spray a powder of a predetermined composition. Other overlay coating processes, such as cathodic arc or ion plasma deposition, which deposit macroparticles and atoms, can also produce coatings that are less than desirable in surface finish and density, particularly on surfaces coated at low deposition angles.

Another frequently used method is to apply a coating by placing the substrate in an elevated temperature atmosphere that has a high concentration of a preselected element or elements in a gaseous phase. Typically, the preselected elements include at least aluminum. These methods include vapor phase aluminiding (VPA) and chemical vapor deposition (CVD) methods. The aluminide coating is formed as the preselected element or elements diffuse into the substrate, combining with elements already present in the substrate, such as nickel. These coatings are referred to as diffusion coatings, and the composition will vary with increasing distance from the surface. Concomitantly, the structure can vary with the composition. In this circumstance, the coating will not likely have a substantially stoichiometric composition throughout. In addition, in such processes it is difficult to control the addition of other elements, such as rare earths, to the coating to improve oxidation performance.

A third method of applying the coating that is frequently used includes electroplating. Here the substrate is placed in an electrolytic bath that includes metallic ions, typically Ni or Pt, but also Al. A thin coating is deposited on the substrate by passage of an electrical current through the substrate and ion bath. Powder particles of the same or alternate compositions may also be incorporated in the plated deposit through entrapment plating operations. The aluminide is then formed by exposing the plated substrate to Al by one of the above methods. Again, the coating formed is a diffusion coating. Diffusion coatings may include some of the β-phase.

The inherent problem with all of these methods is that when a substantially stoichiometric composition of a β-phase NiAl coating across the surface of the substrate is achieved, very little can be done to modify the surface of the coated substrate due to the brittle nature of the β-phase NiAl intermetallic. Thus, certain key quality characteristics may not be readily achievable by these prior art methods. These include the correct degree of coating density and the proper surface roughness as the brittle nature of the intermetallic NiAl precludes mechanical working the coated substrate. Surface roughness, particularly associated with thermal spray techniques, is desirably reduced for reasons of coating performance and aerodynamic efficiency

What is needed are cost effective methods that can be employed to modify surface roughness and, if possible, density, of a substantially stoichiometric composition of β-phase aluminide coatings, such as NiAl and PtAl, over the surface of a substrate such as a turbine airfoil without adversely affecting the brittle substrate. The method used to modify the surface of the stoichiometric composition of the coated substrate should control the final surface roughness of the coated article, and preferably if possible, the density of the applied coating by desirably acting on the substrate at elevated temperatures without causing the brittle β-phase aluminide coating to be damaged.

### SUMMARY OF THE INVENTION

Improvements in manufacturing technology and materials are the keys to increased performance and reduced costs for many articles. As an example, continuing and often interrelated improvements in processes and materials have resulted in major increases in the performance of aircraft gas turbine engines. Technology including the composition and manner in which coatings are applied to a substrate can improve substrate life and performance. Currently, most as-manufactured NiAl applied as coatings by thermal spray techniques are neither sufficiently smooth nor sufficiently dense to achieve the full benefits of the NiAl coating. This is particularly an issue in tight fitted regions and other regions where direct line-of-sight access is restricted which is required for thermal spray applications. One method of applying a nickel aluminide coating is by a thermal spray process, such as the high velocity oxy-fuel (HVOF) process in which a substantially stoichiometric composition is applied to the substrate. Spray processes such as HVOF produce a surface roughness typically in the range of 100-240 micro-inches, with a common roughness in the range of 150-210 micro inches. If the surface formed by the HVOF spray is not stoichiometric, for example, if it is rich in Ni, then stoichiometry may be achieved by exposing the surface to an atmosphere rich in Al followed by a suitable heat treatment. However, these subsequent heat treatments will not affect the as-sprayed surface finish formed by the HVOF process, nor will it affect the density. A smoother surface is desired, as it will allow for better adhesion of a ceramic TBC, while a denser coating will improve the corrosion and oxidation performance of the coating over the operational life cycle of the part. Another method of applying a NiAl coating is by ion plasma deposition. Surface finishes can be 100-140 microinches, and densities can be less than desirable at unfavorable deposition angles. As for HVOF, smooth and dense coatings are preferred for durability.

In order to achieve the required surface finish and a desired density of an environmental coating that includes at least some and substantially all of the brittle β-phase aluminide, the coated article can be worked by one or a combination of known controlled mechanical techniques. As described in U.S. Pat. No. 6,403,165, incorporated herein by reference, one such technique includes impinging the surface of the room temperature coated article with room temperature particles of preselected size for a preselected time and at low peening intensity to provide a smoother surface finish and hopefully improved density of the coating without adversely affecting the brittle coating material. The impingement techniques described in U.S. Pat. No. 6,403,165 represent a novel use of such techniques to improve the surface finish of stoichiometric NiAl coatings applied to turbine airfoils. However, while the impingement techniques described in U.S. Pat. No. 6,403,165 produce a reasonably smooth NiAl coating, the density is not substantially increased. Those techniques also require further finishing operations as well as numerous process controls in order to prevent damage to the rather brittle NiAl coating. For example, selection of peening media is essentially limited to steel balls of preselected size of 0.033″ and a peening intensity of 6 A (on the Almen scale) to prevent chipping and breaking of the brittle coating, especially on the edges of the airfoil. Another limitation of known peening methods results from the structure of airfoils, which have small cooling holes in intricate patterns. These cooling holes must be kept free of obstructions. Using known room temperature peening methods, friable media must be avoided, since fractionation could result in the undesirable lodging of fractions in the cooling holes. To avoid this problem, known methods utilize only non-friable media such as spherical steel shot having a diameter larger than the cooling hole diameter sizes.

The techniques of the present invention represent novel improvements in post-deposition treatment and modification of brittle β-phase NiAl coatings. Although they are not limited to β-phase NiAl coatings and can be used in NiAl diffusion coatings, the process is of particular usefulness with β-phase NiAl since it increases the coating smoothness and density by heating of the article to near the brittle-ductile transition temperature of the coating, followed by impingement of the heated article with peening media. Heating of the coated article to near, or alternatively above, the brittle-ductile transition temperature of the coating allows for limited plastic flow of the coating during surface impingement.

In other techniques disclosed herein, the peening media is also heated to an elevated temperature, allowing a broader selection of media. The methods of the present invention involve heating of the peening media to make the peening media more ductile, improving plasticity of the media and thereby reducing fractionation and minimizing the possibility that the peening media will quench or lower the coating temperature below the brittle-ductile transition temperature. Thus, the present invention permits use of a peening media not usable with room-temperature peening techniques, including more friable peening media such as glass, zirconia, ceramics, most intermetallics, and composites, as well as non-friable media such as metals.

An advantage of the present invention is the ability to tailor the surface roughness of a brittle, substantially stoichiometric β-phase aluminide coating such as NiAl or PtAl. In this way, the inherent advantages of a thermally sprayed β-phase composition can be utilized, while the brittle nature of the composition can be overcome so that the surface finish of the article can be modified to achieve the same results currently achievable for non-stoichiometric compositions that are either low in Ni or low in Al, or for stoichiometric compositions applied by PVD, VPA, or CVD methods. While the present invention was developed for use with β-phase NiAl, which is brittle, it may be used advantageously with any other coating with an unacceptably rough surface finish due to application techniques and that is inherently brittle or includes brittle phases, but which requires a smooth final surface finish for proper performance. Typically, these phases have a higher Al content than other, more ductile coatings and are identified as β-phases, and the coatings contain a substantial amount of the β-phases or are primarily β-phases.

Another advantage of the present invention is the ability to increase the density of a brittle coating without damaging it. While intended for use with β-phase NiAl, the present invention can be used with any aluminide or other coating that is brittle or contains brittle phases and has a brittle-ductile transition temperature. The methods of the present invention can modify the as-sprayed coating to achieve the required surface finish and desired density in order to take advantage of the improved corrosion and oxidation capabilities of the smoother, denser coating without damaging the brittle coating. Airfoils that have had their surface finish modified in accordance with the present invention will have a more aerodynamic gas flow path that serves to improve efficiency. Additionally, it is expected that furnace cycle testing (FCT) performance will improve as the surface finish is improved, which is an indication of improved thermal performance, or alternatively, resistance to spalling of a thermal barrier coating applied on top of the NiAl bond coat.

Still another advantage of the methods of the present invention is that they can be applied to both new airfoils and to airfoils that have undergone repair. These methods provide a simple, effective technique for achieving a smooth and dense β-phase NiAl coating that is cost effective and that can provide an adequate substitute for aluminide coatings that have a PtAl component.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross sectional view illustrating an apparatus and method for practicing the invention using a plasma gun modified to deliver heated peening media to impinge a coated substrate.

FIG. 2 is a cross sectional view illustrating an apparatus and method for practicing the invention using a combustion gun such as an HVOF gun to modified to deliver heated peening media to impinge a coated substrate.

Wherever possible, the same reference numbers will be used throughout the drawings to refer to the same or like parts.

### DETAILED DESCRIPTION OF THE INVENTION

The present invention can be used on any turbine airfoil or flowpath part of a gas turbine engine coated with a brittle coating, such as a substantially stoichiometric β-phase NiAl coating, by a thermal spray process that results in a rough surface finish having a desired density and surface finish. The turbine airfoils typically requiring such protection are the high pressure turbine blades and high pressure vanes found immediately aft of the combustor portion of a turbine engine. While any β-phase NiAl or PtAl coating may be applied, it is preferred to use a substantially stoichiometric composition that includes small additions of rare earth elements such as zirconium (Zr), hafnium (Hf), yttrium (Y), lanthanum (La) and La-series elements, chromium (Cr), cesium (Cs), calcium (Ca), magnesium (Mg). Other elements may include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu) as well as certain other elements such as, but not limited to Group IVa and VIa elements. These elements are added in an amount that does not substantially modify the structure of the β-phase NiAl or PtAl coating and can be added in any combination. These additions, when provided on a substitutional basis, are known to produce a coating having improved oxidation resistance as well as resistance to spallation of the thermal barrier coating.

The coating may be applied by any method that can produce a substantially stoichiometric β-phase composition. As used herein, a “substantially stoichiometric” means an alloy that has a substantially ordered intermetallic structure of nickel (or platinum) and aluminum atoms, although certain of the alloy additions discussed above may be included, typically on a substitutional basis, for atoms in the ordered matrix. The composition comprises Al from about 37-76 at. % (atomic percent) or about 38-53 wt %, and the balance substantially Ni. As noted above, elements may be added in any fashion as long as the structure of the coating is substantially unaffected (i.e. new phases that could be formed are<50 vol. %). Preferred methods include exposing the substrate to a powder having a composition identical to or very close to the final desired composition. These include thermal spray techniques and in particularly, low pressure plasma spray (LPPS) or vacuum plasma spray (VPS) and high velocity oxy-fuel (HVOF) in which powder is heated near or above its melting temperature and directed at the substrate.

Known thermal spray techniques typically produce a rough surface finish of the order of about 150 micro inches or greater. However, a surface finish of less than about 50 micro-inches is preferred so that the TBC system applied over the environmental coating for thermal protection is more durable. If the surface finish is above the desired range, the life of the TBC is reduced, as there is an increased tendency for the TBC to spall, thereby reducing the operating life of the component. However, the β-phase NiAl intermetallic is a brittle coating, and in order to achieve a desired surface finish of 120 micro inches and finer, it is necessary to modify the coating. Typical methods of modifying the coating include post-deposition modification including heat treatment or room temperature shot peening, followed by tumbling. These multiple operations can produce a smooth coating, but are time consuming and costly, and often do not suitably densify the coating in critical locations.

In addition to smoothness, coating density is also important, but is more difficult to quantify. A less dense coating has been found to be less effective in protecting the blade from the corrosive and oxidative effects of the hot gases of combustion and corrosion products collected as deposits to which it is subjected. Pores in the coating can increase coating internal oxidation due to the higher surface area presented to the atmosphere. Not only is corrosion and oxidation increased, but as the coating deteriorates locally, spalling of any applied TBC also increases in those affected areas. It is believed that as the coating is made smoother by the novel mechanical processing of the present invention, the coating is simultaneously made denser. Preferably, the surface is modified by the present invention to achieve a finish of about 120 micro-inches and finer. More preferably, the surface finish is about 80 micro-inches and finer. Most preferably, the surface finish is about 50 micro-inches and finer.

Several effective methods for improving the surface finish of the coating by reducing the surface roughness which do not adversely impact the brittle stoichiometric NiAl coating are provided. In one embodiment, the coated article is heated until the bulk article (article plus the coating) reaches a preselected temperature of between 300° F. to 600° F. (148° C. to 315° C.). However, because the article, such as airfoils and other flowpath parts for turbine engines, are designed for use at temperatures above 1600° F., higher temperatures may be used, as long as the peening media and intensity remain unaffected by such temperatures. More preferably, the temperature is between 400° F. and 500° F. (204° C. to 260° C.). Most preferably, the preselected temperature range is near, but does not exceed, the brittle-ductile transition temperature for the coating, so as to allow limited plastic flow of the coating during surface compression by impingement. The brittle-ductile transition temperatures for various substantially stoichiometric β-phase NiAl and PtAl coatings are well known and available in authoritative metallurgical treatises, such as the Metals Handbook. Alternatively, the transition temperatures, and any variation to the required temperature to compensate for the effects of compressive force of the impinging media, can be determined by those skilled in the art without undue experimentation. In this embodiment, the heated article is next impinged using particles of a preselected diametrical size to contact the heated article with a preselected peening intensity. Some exemplary impinging media include glass, zirconia, ceramics (such as oxide or metallic ceramics), composites, metals such as steel, intermetallics (such as nickel aluminides and superalloys), and other known peening media. Impingement methods include thermal spray guns, shot peening guns, dry grit blasting apparatus, gravity peening or other apparatus and methods known to those skilled in the art of impingement to improve the surface finish and increase the density of the coatings.

In a preferred embodiment, the methods involve heating the bulk article to the near-ductile transition temperature of the coating, followed by impinging of the article using heated peening media of a preselected diametrical size to contact the coating with a preselected intensity. Heating of the media provides increased plasticity of the media, thereby decreasing friability of the media, but more importantly, decreases the local cooling effects that room temperature media and high gas flows to propel media may have on the coating. The temperature of the heated media is preferably well below the melting point of the media. Heating of the media results in a softened impact against the coated surface, making the coating less likely to chip or break during impinging. This is especially advantageous in modifying the coated surface at the leading and trailing edges of airfoils, for example, where known room temperature peening methods frequently cause chipping and breaking of the coating. The selection of the media likely will dictate the temperature to which it is heated. The diametrical size of the media must be such that the cooling holes remain unaffected, and the media does not become trapped in the internal surfaces of the component (as in the case of a hollow turbine airfoil).

The peening media may be heated by a number of methods, including but not limited to pre-heating in an oven or in a heated media reservoir such as a heated shot peen cabinet. Alternatively, the media is simultaneously heated and propelled, such as, for example, by introduction into a thermal stream. In this preferred embodiment, the particle heating and acceleration is accomplished by introduction of the media into a thermal spray gun assembly so that the media is heated and propelled through the nozzle. Alternatively, peening media heating and acceleration can be accomplished by introduction of peening media outside of the gun, such as by dry grit blasting apparatus, preferably directing the media into the thermal spray stream for heating before reaching the coated article.

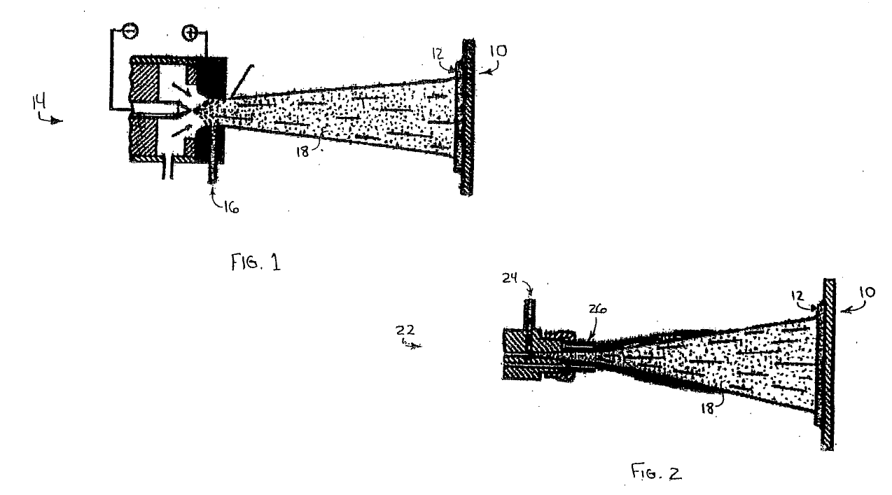

FIGS. 1-2 illustrate the preferred embodiments of the invention. In FIG. 1, a heated coated article 10 is provided having a coating 12. A plasma gun 14 is provided, the plasma gun including an injection port 16 for introduction of peening media 18. Upon injection, the peening media 18 is heated by the plasma flame and propelled through the gun nozzle 20 towards the coating 12. The heated, propelled media 18 impinges the coating 12, resulting in smoothing and densification of the coating 12.

FIG. 2 illustrates another preferred embodiment of the invention. In FIG. 2, a heated coated article 10 is provided having a coating 12. A combustion gas gun 22, such as an HVOF thermal spray gun, is provided. The combustion gas gun includes an injection port 24 for introduction of peening media 18. Upon injection, the peening media 18 is heated by the plasma flame and propelled through the gun nozzle 26 towards the coating 12. The heated, propelled media 18 impinges the coating 12, resulting in smoothing and densification of the coating 12.

In any embodiment, the peening intensity can be adjusted based upon the initial roughness of the coating, desired smoothness and density, the selection of peening media, and the desired temperature of the heated coated article. In embodiments where the peening media is also heated, actual peening intensity will further vary depending upon the effect of temperature on the media. Peening intensity is measured by peening a strip of Almen material, either A-type or N-type, for a sufficient length of time to achieve 100% to 500% coverage of the surface. The amount of material deflection is measured in mils and the measure of the deflection is the peening intensity. Thus, if an A-type Almen strip is used, and deflection is measured to be 6 mils, then a 6 A peening intensity is achieved. The A scale is the less severe peening scale. Using the method of the present invention, a peening intensity of between 1 A and 10 A is preferably selected based on the factors previously identified herein.

While the present invention has been described in terms of stoichiometric β-phase nickel aluminide coating applied to turbine blades as an environmental or bond coating, it will be understood that the invention can be used for any other brittle coating or coating that includes a brittle phase. This may permit the use of coatings that previously may not have been considered because of the inability to obtain the necessary surface finish for application of a ceramic TBC or density desired for protection. One example is the MCrAlX bond coats where M is an element selected from the group consisting of Ni, Fe, Co or combinations thereof and X is usually yttrium. This alloy is in common use as a bond coat, but the chemical composition is such that it is used as a gamma prime coating. MCrAlX bond coats typically are either gamma/gamma prime hardenable or are simply non-hardenable gamma phase, including only about 8-10 weight percent aluminum (about 20 atomic percent Al and lower) and X is at least one element selected from the group consisting of Y, Zr, Hf, La, Sc, Ti, Si, and Re. The presence of a substantial amount of Cr added for corrosion protection also stabilizes the β-phase within a gamma matrix. The present invention may allow for the use of a β-phase MCrAlX applied by thermal spray, which has been avoided until now because of its brittle nature. The present invention can be used to reduce the surface roughness, such as is typically formed by thermal spraying or plasma deposition, of a substantially β-phase MCrAlX having higher amounts of Al, from about 20-60 atomic percent, and lower amounts of Cr, from 0 to about 20 atomic percent than a gamma or gamma/gamma prime phase MCrAlX.

Although the present invention has been described in connection with specific examples and embodiments, those skilled in the art will recognize that the present invention is capable of other variations and modifications within its scope. These examples and embodiments are intended as typical of, rather than in any way limiting on, the scope of the present invention as presented in the appended claims.

1. A method for improving the surface finish of a coating applied to a turbine component comprising the steps of:
applying a coating having a substantially stoichiometric NiAl composition to a surface of the turbine component that includes an aluminum rich beta phase using an overlay process, the applied coating having a surface roughness in the range of 100 to 240 micro-inches;
heating the coated turbine component; and
peening the coated surface of the component by impinging with media of a preselected size at a preselected intensity to provide a maximum surface roughness of 120 micro-inches and smoother while simultaneously improving coating density without adversely affecting the coating.

2. The method of claim 1, wherein the turbine component further includes cooling apertures and the preselected size of the media is greater than the cooling aperture diameter.

3. The method of claim 1, wherein the turbine component is selected from the group consisting of airfoils, turbine blades, turbine vanes, combustor components, and turbine shrouds.

4. The method of claim 1 wherein the coating applied to the turbine component is a substantially beta-phase NiAl coating having a composition of Al in atomic percent of about 37% to about 73%, and the balance Ni and incidental impurities

5. The method of claim 4, wherein the composition of the coating includes substitutional elements selected from the group consisting of Zr, Hf. La, Cr, Cs, Ca, Mg, Ce, Pr, Nd, Pm, Sm, Eu, Gd, Tb, Dy, Ho, Er, Tm, Yb and Lu in amounts that do not affect the ordered intermetallic structure of NiAl.

6. The method of claim 4 wherein the media impinging the coated surface of the turbine component is selected from the group consisting of glass, zirconia, ceramic, metallic ceramics, metals, and intermetallics.

7. The method of claim 6, wherein the step of heating the coated turbine component includes elevating the temperature of the coated component to a temperature near a brittle-ductile transition temperature of the coating.

8. The method of claim 7 wherein the step of peening the coated surface of the component further comprises the step of peening the coated surface of the component with the media of preselected size at the preselected intensity for a time sufficient to provide the coated surface with a maximum surface roughness of less than about 80 micro-inches.

9. The method of claim 8 wherein the step of peening the coated surface of the component further comprises the step of peening the coated surface of the component with the media of the preselected size at the preselected intensity for a time sufficient to provide a maximum surface roughness of less than about 50 micro-inches.

10. The method of claim 8 wherein the media impinging the coated surface of the component comprises media having a diametrical size of about 30 mils and larger and the preselected intensity is between 1 A to 10 A.

11. A method for improving the surface finish of a coating applied to a turbine component comprising the steps of:
applying a coating having a substantially stoichiometric NiAl composition to the surface of the component, the coating including an aluminum rich beta phase using an overlay coating process, said applied coating having a surface roughness in the range of 100 to 240 micro-inches; then
heating the coated turbine component into a preselected temperature range; and
impinging the coated surface of the heated, coated turbine component employing a heated peening media heated into the preselected temperature range, of preselected size, at a preselected intensity to provide a maximum surface roughness of 120 micro-inches while simultaneously improving coating density without adversely affecting the coating.

12. The method of claim 11 wherein the coating applied to the turbine component is a beta-phase NiAl coating having a composition of Al in atomic percent of about 37% to about 73%, and the balance Ni and substitutional elements and incidental impurities

13. The method of claim 12, wherein the composition of the coating includes substitutional elements selected from the group consisting of Zr, Hf, La, Cr, Cs, Ca, Mg., Ce, Pr, Nd, Pm, Sm, Eu, Gd, Tb, Dy, Ho, Er, Tm, Yb and Lu in amounts that do not affect the ordered intermetallic structure of NiAl.

14. The method of claim 12 wherein impinging is accomplished using media selected from the group consisting of glass, zirconia, ceramic, metallic ceramics, metals, and intermetallics.

15. The method of claim 11, wherein the step of heating the coated turbine component into a preselected temperature range includes elevating the temperature of the coated turbine component to a temperature near a brittle-ductile transition temperature of the coating.

16. The method of claim 14 wherein the step of impinging the coated surface of the turbine component employing heated peening media further comprises the step of impinging the coated surface of the turbine component with the peening media of the preselected size at the preselected intensity for a preselected time to provide a maximum surface roughness of 80 micro-inches.

17. The method of claim 14 wherein the step of impinging the coated surface of the turbine component employing heated peening media further comprises the step of impinging the coated surface of the turbine component with the media of the preselected size at the preselected intensity for a preselected time to provide a maximum surface roughness of about 50 micro-inches.

18. The method of claim 14 wherein the media has a diametrical size of at least about 0.030 inches.

19. The method of claim 14 wherein the step of impinging is performed for a preselected time sufficient to provide 500% coverage maximum.

20. The method of claim 14 wherein the step of impinging is performed by introducing peening media into a thermal stream produced by a thermal spray gun, thereby simultaneously heating and propelling the media toward the turbine component.

21. A turbine component made by the process of:
applying a coating composition to the component using an overlay coating process, the applied coating having a surface roughness in the range of 100 to 240 micro-inches;
heating the coated component to a temperature within a preselected temperature range; and
peening the coated surface of the airfoil by impinging with media of a preselected size at a preselected intensity to provide a maximum surface roughness of 120 micro-inches while simultaneously improving coating density without adversely affecting the coating.

22. The method of claim 21, wherein the turbine component further includes cooling apertures and the preselected size of the media is greater than the cooling aperture diameter.

23. The method of claim 21, wherein the overlay coating process is a thermal spray process selected from the group consisting of low pressure plasma spray (LPPS), vacuum plasma spray (VPS), high velocity oxy-fuel (HVOF), air plasma spray (APS) and detonation gun (D-gun).

24. The coated turbine component of claim 23, wherein the process further includes the step of heating the peening media prior to impinging to a temperature within the preselected temperature range.

25. The coated turbine component of claim 24, wherein the process utilizes media selected from the group consisting of glass, zirconia, ceramic, metallic ceramics, metals, and intermetallics.

26. The coated turbine component of claim 25, wherein the process utilizes media having a diametrical size of at least about 0.030 inches.
